(19) United States
(12) Patent Application Publication
(10) Pub. No.: US 2025/0310060 A1
(43) Pub. Date: Oct. 2, 2025

(54) REFERENCE SIGNAL EXTRAPOLATION FOR CHANNEL ESTIMATION

(71) Applicant: QUALCOMM Incorporated, San Diego, CA (US)

(72) Inventors: Chih-Hao LIU, San Diego, CA (US); Jing SUN, San Diego, CA (US); Junyi LI, Greentown, PA (US); Yi HUANG, San Diego, CA (US); Mostafa KHOSHNEVISAN, San Diego, CA (US); Jing JIANG, San Diego, CA (US)

(21) Appl. No.: 18/623,978

(22) Filed: Apr. 1, 2024

(51) Int. Cl. H04L 5/00; H04B 7/06; H04W 8/22

(52) U.S. Cl. CPC H04L 5/0051; H04B 7/0626; H04L 5/0078; H04W 8/22

(57) ABSTRACT

Methods, systems, and devices for wireless communications are described. A user equipment (UE) may receive one or more demodulated reference signals (DMRSs) during a first time interval. The UE may receive control messages indicating to use channel estimate information associated with the one or more DMRSs received during the first time interval for demodulating a data channel during a second time interval, where the second time interval occurs temporally after the first time interval. In some examples, the control messages may include an indication of a time span prior to the second time interval that defines a duration of the first time interval. As such, the UE may generate a channel estimate of the data channel for the second time interval based on the one or more DMRSs received during the first time interval and demodulate, via the data channel, a data transmission based on the channel estimate information.

### FIELD OF TECHNOLOGY

The following relates to wireless communications, including reference signal extrapolation for channel estimation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support reference signal extrapolation for channel estimation. For example, the described techniques provide for a network entity to indicate one or more portions of previous demodulated reference signals (DMRSs) for a user equipment (UE) to use for performing a channel estimation of a current channel. For example, the UE may receive one or more DMRSs during a first time interval. As such, the network entity may indicate to the UE to use the channel estimate information associated with the one or more DMRSs for demodulating a data channel during a current time interval which occurs temporally after the first time interval. In some examples, the network entity may indicate that the UE may leverage the DMRSs included in a defined time span prior to the second time interval (e.g., a combining time span). Additionally, or alternatively, the network entity may indicate for a subset of DMRSs from the one or more DMRSs that correspond to a same transmission configuration indicator (TCI) state group as the current time interval. Additionally, or alternatively, the network entity may indicate a subset of frequency tones across the one or more DMRSs that correspond to a same precoder used for the channel of the current time interval. Additionally, or alternatively, the UE may indicate a UE capability for leveraging pervious DMRSs, where the one or more DMRSs indicated by the network entity may be based on the UE capability.

A method for wireless communications by a UE is described. The method may include receiving one or more DMRSs during a first time interval, receiving one or more control messages indicating for the UE to use channel estimate information associated with the one or more DMRSs received during the first time interval for demodulating a data channel during a second time interval, where the second time interval occurs temporally after the first time interval, and demodulating, via the data channel, a data transmission based on the channel estimate information.

A UE for wireless communications is described. The UE may include one or more memories storing processor executable code, and one or more processors coupled with the one or more memories. The one or more processors may individually or collectively be operable to execute the code to cause the UE to receive one or more DMRSs during a first time interval, receive one or more control messages indicating for the UE to use channel estimate information associated with the one or more DMRSs received during the first time interval for demodulating a data channel during a second time interval, where the second time interval occurs temporally after the first time interval, and demodulate, via the data channel, a data transmission based on the channel estimate information.

Another UE for wireless communications is described. The UE may include means for receiving one or more DMRSs during a first time interval, means for receiving one or more control messages indicating for the UE to use channel estimate information associated with the one or more DMRSs received during the first time interval for demodulating a data channel during a second time interval, where the second time interval occurs temporally after the first time interval, and means for demodulating, via the data channel, a data transmission based on the channel estimate information.

A non-transitory computer-readable medium storing code for wireless communications is described. The code may include instructions executable by one or more processors to receive one or more DMRSs during a first time interval, receive one or more control messages indicating for the UE to use channel estimate information associated with the one or more DMRSs received during the first time interval for demodulating a data channel during a second time interval, where the second time interval occurs temporally after the first time interval, and demodulate, via the data channel, a data transmission based on the channel estimate information.

Some examples of the method, UEs, and non-transitory computer-readable medium described herein may further include operations, features, means, or instructions for generating a channel estimate of the data channel for the second time interval based on the channel estimate information associated with the one or more DMRSs received during the first time interval, where demodulating the data transmission may be based on the channel estimate.

Some examples of the method, UEs, and non-transitory computer-readable medium described herein may further include operations, features, means, or instructions for receiving, as part of the one or more control messages, an indication of a time span prior to the second time interval that defines a duration of the first time interval, where the one or more DMRSs included in the first time interval may be based on the time span indicated in the one or more control messages.

In some examples of the method, UEs, and non-transitory computer-readable medium described herein, a first control message of the one or more control messages indicates the time span of the first time interval and a second control message of the one or more control messages indicates for the UE to use the channel estimate information associated with the one or more DMRSs received during the first time interval for demodulating the data channel.

In some examples of the method, UEs, and non-transitory computer-readable medium described herein, a duration of the time span may be based on doppler information associated with the data channel, a buffer storage size of the UE, or both.

In some examples of the method, UEs, and non-transitory computer-readable medium described herein, a first set of DMRSs may be associated with a first set of DMRS symbols and a first TCI state group and a second set of DMRSs may be associated with a second set of DMRS symbols and a second TCI state group.

In some examples of the method, UEs, and non-transitory computer-readable medium described herein, the first set of DMRSs includes the one or more DMRSs received during the first time interval and the method, apparatuses, and non-transitory computer-readable medium may include further operations, features, means, or instructions for receiving, as part of the one or more control messages, an indication of a DMRS symbol index that indicates the first set of DMRS symbols associated with the first set of DMRSs, where the channel estimate information may be based on the first set of DMRSs.

In some examples of the method, UEs, and non-transitory computer-readable medium described herein, the first set of DMRSs includes the one or more DMRSs received during the first time interval and the method, apparatuses, and non-transitory computer-readable medium may include further operations, features, means, or instructions for receiving, as part of the one or more control messages, an indication for the UE to use the channel estimate information associated with the first set of DMRSs for demodulating the data channel based on the first set of DMRSs and the data channel being associated with the first TCI state group.

In some examples of the method, UEs, and non-transitory computer-readable medium described herein, a first set of DMRS tones may be associated with a first set of precoding resource groups (PRGs) associated with a first precoder and a second set of DMRS tones may be associated with a second set of PRGs associated with a second precoder.

In some examples of the method, UEs, and non-transitory computer-readable medium described herein, the first set of DMRS tones corresponds to the one or more DMRSs received during the first time interval and the method, apparatuses, and non-transitory computer-readable medium may include further operations, features, means, or instructions for receiving, as part of the one or more control messages, an indication for the UE to use the channel estimate information associated with the first set of DMRS tones for demodulating the data channel based on the first set of DMRS tones and the data channel being associated with the first precoder.

In some examples of the method, UEs, and non-transitory computer-readable medium described herein, the indication for the UE to use the channel estimate information associated with the first set of DMRS tones includes an indication of each PRG of the first set of PRGs associated with the first precoder.

In some examples of the method, UEs, and non-transitory computer-readable medium described herein, the indication for the UE to use the channel estimate information associated with the first set of DMRS tones includes a bit map, each bit of the bit map may be associated with a respective PRG included within the one or more DMRSs, and each bit of the bit map associated with a PRG of the first set of PRGs may be set to a first value that indicates for the UE to use the channel estimate information associated with the first set of PRGs.

In some examples of the method, UEs, and non-transitory computer-readable medium described herein, the first set of PRGs may be contiguous across a first set of frequency resources and the second set of PRGs may be contiguous across a second set of frequency resources, the indication for the UE to use the channel estimate information associated with the first set of DMRS tones includes a bit map, and a first bit of the bit map may be associated with the first set of PRGs and set to a first value that indicates for the UE to use the channel estimate information associated with the first set of PRGs.

Some examples of the method, UEs, and non-transitory computer-readable medium described herein may further include operations, features, means, or instructions for transmitting a capability message that indicates one or more parameters associated with using one or more previous DMRSs to perform channel estimation for data channel demodulation, where the one or more control messages may be received based on the capability message.

In some examples of the method, UEs, and non-transitory computer-readable medium described herein, the one or more parameters include a maximum time span prior to the second time interval, a quantity of one or more prior DMRS symbols, a quantity of one or more spatial layers, a quantity of one or more antennas at the UE, a quantity of one or more TCI groups, a quantity of one or more prior DMRS resource blocks, a capability of the UE for storing temporal information associated with DMRSs, a capability of the UE for storing spatial information associated with DMRSs, and a capability of the UE for storing frequency information associated with DMRSs, or a combination thereof.

In some examples of the method, UEs, and non-transitory computer-readable medium described herein, the one or more parameters include a maximum time span prior to the second time interval, a quantity of DMRS resource elements across a temporal domain, a frequency domain, and a spatial domain, or a combination thereof.

In some examples of the method, UEs, and non-transitory computer-readable medium described herein, the channel estimate information associated with the one or more DMRSs includes a respective set of DMRS tones associated with a respective DMRS of the one or more DMRSs, a respective channel estimate associated with a respective DMRS of the one or more DMRSs, or both and the channel estimate information may be stored at a buffer of the UE.

A method for wireless communications by a network entity is described. The method may include outputting one or more DMRSs during a first time interval, outputting one or more control messages indicating for a UE to use channel estimate information associated with the one or more DMRSs transmitted during the first time interval for demodulating a data channel during a second time interval, where the second time interval occurs temporally after the first time interval, and outputting, via the data channel, a data transmission.

A network entity for wireless communications is described. The network entity may include one or more memories storing processor executable code, and one or more processors coupled with the one or more memories. The one or more processors may individually or collectively be operable to execute the code to cause the network entity to output one or more DMRSs during a first time interval, output one or more control messages indicating for a UE to use channel estimate information associated with the one or more DMRSs transmitted during the first time interval for demodulating a data channel during a second time interval, where the second time interval occurs temporally after the first time interval, and output, via the data channel, a data transmission.

Another network entity for wireless communications is described. The network entity may include means for outputting one or more DMRSs during a first time interval, means for outputting one or more control messages indicating for a UE to use channel estimate information associated with the one or more DMRSs transmitted during the first time interval for demodulating a data channel during a second time interval, where the second time interval occurs temporally after the first time interval, and means for outputting, via the data channel, a data transmission.

A non-transitory computer-readable medium storing code for wireless communications is described. The code may include instructions executable by one or more processors to output one or more DMRSs during a first time interval, output one or more control messages indicating for a UE to use channel estimate information associated with the one or more DMRSs transmitted during the first time interval for demodulating a data channel during a second time interval, where the second time interval occurs temporally after the first time interval, and output, via the data channel, a data transmission.

Some examples of the method, network entities, and non-transitory computer-readable medium described herein may further include operations, features, means, or instructions for outputting, as part of the one or more control messages, an indication of a time span prior to the second time interval that defines a duration of the first time interval, where the one or more DMRSs included in the first time interval may be based on the time span indicated in the one or more control messages.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports reference signal extrapolation for channel estimation in accordance with one or more aspects of the present disclosure.

FIG. 2 shows an example of a network architecture that supports reference signal extrapolation for channel estimation in accordance with one or more aspects of the present disclosure.

FIG. 3 shows an example of a wireless communications system that supports reference signal extrapolation for channel estimation in accordance with one or more aspects of the present disclosure.

FIGS. 4A and 4B each show a respective example of a demodulated reference signal (DMRS) extrapolation scheme that supports reference signal extrapolation for channel estimation in accordance with one or more aspects of the present disclosure.

FIG. 5 shows an example of a process flow that supports reference signal extrapolation for channel estimation in accordance with one or more aspects of the present disclosure.

FIGS. 6 and 7 show block diagrams of devices that support reference signal extrapolation for channel estimation in accordance with one or more aspects of the present disclosure.

FIG. 8 shows a block diagram of a communications manager that supports reference signal extrapolation for channel estimation in accordance with one or more aspects of the present disclosure.

FIG. 9 shows a diagram of a system including a device that supports reference signal extrapolation for channel estimation in accordance with one or more aspects of the present disclosure.

FIGS. 10 and 11 show block diagrams of devices that support reference signal extrapolation for channel estimation in accordance with one or more aspects of the present disclosure.

FIG. 12 shows a block diagram of a communications manager that supports reference signal extrapolation for channel estimation in accordance with one or more aspects of the present disclosure.

FIG. 13 shows a diagram of a system including a device that supports reference signal extrapolation for channel estimation in accordance with one or more aspects of the present disclosure.

FIGS. 14 through 17 show flowcharts illustrating methods that support reference signal extrapolation for channel estimation in accordance with one or more aspects of the present disclosure.

### DETAILED DESCRIPTION

In some examples of wireless communications, a user equipment (UE) may receive one or more demodulated reference signals (DMRSs) from a network entity. A DMRS may be a type of reference signal embedded within a data stream or data channel that the UE may use for channel estimation, synchronization, and demodulation purposes. For example, the UE may receive a first DMRS associated with a first physical downlink shared channel (PDSCH), where the UE may perform a channel estimation of the PDSCH based on performing measurements on the first DMRS. In some examples, it may be advantageous for the UE to leverage previously received DMRSs to perform channel estimation on a current channel. However, due to doppler shift some DMRSs in prior slots may be outdated for use in current channel estimation. Additionally or alternatively, one or more DMRSs may be associated with different transmission configuration indicator (TCI) state groups which may correspond to a different set of DMRS ports compared to a current data channel. Additionally or alternatively, different DMRSs may be associated with different precoders compared to a precoder of the current data channel. Additionally or alternatively, a capability for leveraging previous DMRSs for a current channel estimation may change on a UE-to-UE basis.

According to the techniques described herein, the network entity may indicate one or more portions of previous DMRSs for the UE to use for performing a channel estimation of a current channel. For example, the UE may receive one or more DMRSs during a first time interval. As such, the network entity may indicate to the UE to use the channel estimate information associated with the one or more DMRSs for demodulating a data channel during a current time interval which occurs temporally after the first time interval. In some examples, the network entity may indicate that the UE may leverage the DMRSs included in a defined time span prior to the second time interval (e.g., a combining time span). Additionally, or alternatively, the network entity may indicate for a subset of DMRSs from the one or more DMRSs that correspond to a same TCI state group as the current time interval. Additionally, or alternatively, the network entity may indicate a subset of frequency tones across the one or more DMRSs that correspond to a same precoder used for the channel of the current time interval. Additionally, or alternatively, the UE may indicate a UE capability for leveraging pervious DMRSs, where the one or more DMRSs indicated by the network entity may be based on the UE capability.

Aspects of the disclosure are initially described in the context of wireless communications systems, network architecture, DMRS extrapolation schemes, and process flows. Aspects of the disclosure are further illustrated by and described with reference to apparatus diagrams, system diagrams, and flowcharts that relate to reference signal extrapolation for channel estimation.

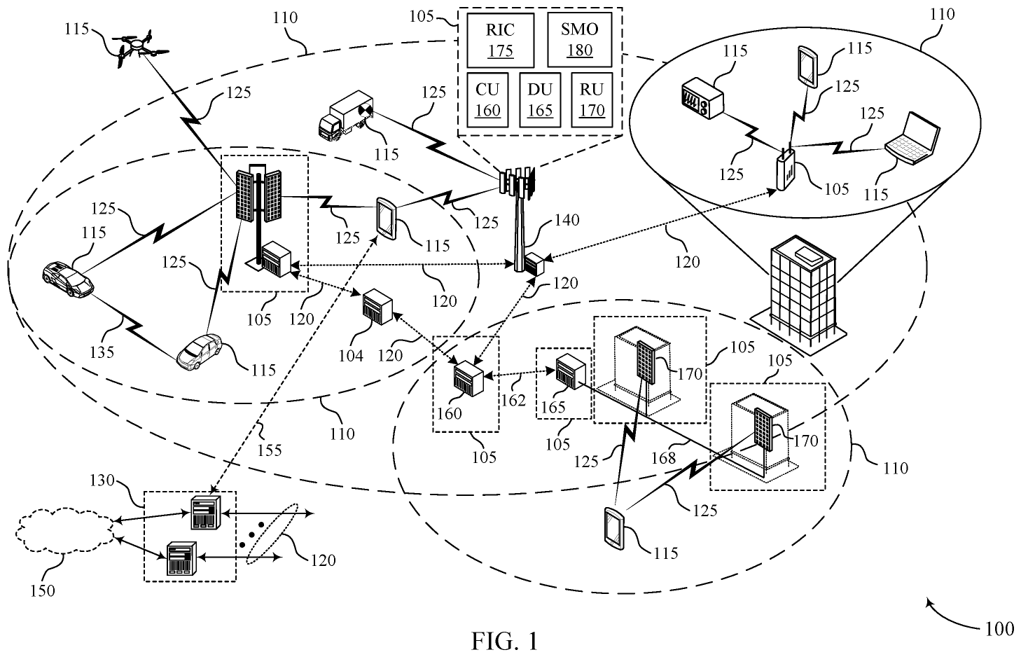

FIG. 1 shows an example of a wireless communications system 100 that supports reference signal extrapolation for channel estimation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples of wireless communications system 100 a network entity 105 may indicate one or more portions of previous DMRSs for the UE 115 to use for performing a channel estimation of a current channel. For example, the UE 115 may receive one or more DMRSs during a first time interval. As such, the network entity 105 may indicate to the UE 115 to use the channel estimate information associated with the one or more DMRSs for demodulating a data channel during a current time interval which occurs temporally after the first time interval. In some examples, the network entity 105 may indicate that the UE 115 may leverage the DMRSs included in a defined time span prior to the second time interval (e.g., a combining time span). Additionally, or alternatively, the network entity 105 may indicate for a subset of DMRSs from the one or more DMRSs that correspond to a same TCI state group as the current time interval. Additionally, or alternatively, the network entity 105 may indicate a subset of frequency tones across the one or more DMRSs that correspond to a same precoder used for the channel of the current time interval. Additionally, or alternatively, the UE 115 may indicate a UE capability for leveraging pervious DMRSs, where the one or more DMRSs indicated by the network entity 105 may be based on the UE capability.

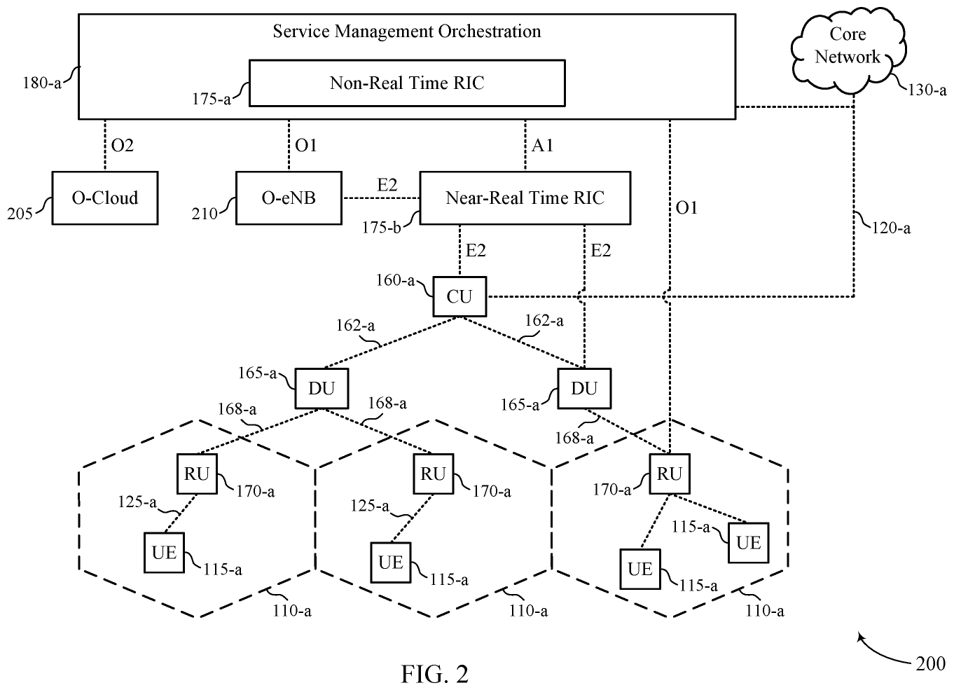

FIG. 2 shows an example of a network architecture 200 (e.g., a disaggregated base station architecture, a disaggregated RAN architecture) that supports reference signal extrapolation for channel estimation in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., AI policies).

In some examples of wireless communications system 100 a network entity 105 may indicate one or more portions of previous DMRSs for the UE 115-a to use for performing a channel estimation of a current channel. For example, the UE 115-a may receive one or more DMRSs during a first time interval. As such, the network entity 105 may indicate to the UE 115-a to use the channel estimate information associated with the one or more DMRSs for demodulating a data channel during a current time interval which occurs temporally after the first time interval. In some examples, the network entity 105 may indicate that the UE 115-a may leverage the DMRSs included in a defined time span prior to the second time interval (e.g., a combining time span). Additionally, or alternatively, the network entity 105 may indicate for a subset of DMRSs from the one or more DMRSs that correspond to a same TCI state group as the current time interval. Additionally, or alternatively, the network entity 105 may indicate a subset of frequency tones across the one or more DMRSs that correspond to a same precoder used for the channel of the current time interval. Additionally, or alternatively, the UE 115-a may indicate a UE capability for leveraging pervious DMRSs, where the one or more DMRSs indicated by the network entity 105 may be based on the UE capability.

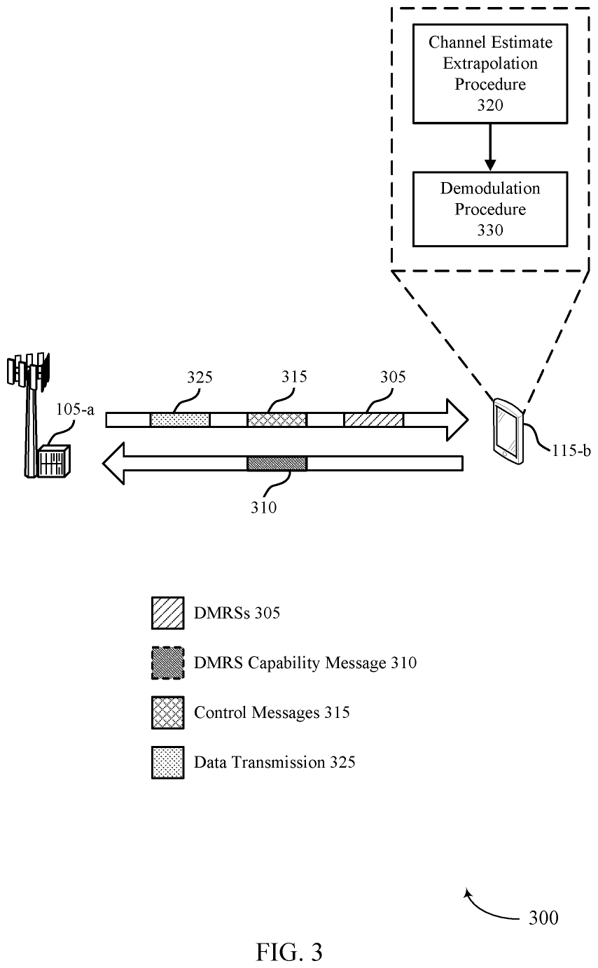

FIG. 3 shows an example of a wireless communications system 300 that supports reference signal extrapolation for channel estimation in accordance with one or more aspects of the present disclosure. The wireless communications system 300 may implement or may be implemented by aspects of the wireless communications system 100 and network architecture 200. For example, the wireless communications system 300 may include a UE 115-b, which may be an example of a UE 115 as described herein. The wireless communications system 300 may include a network entity 105-a, which may be an example of a network entity 105 as described herein.

In some examples of wireless communications system 300, the network entity 105-a and UE 115-b may utilize DMRSs 305. For instance, DMRSs 305 may be reference signals embedded within downlink transmissions (e.g., included in PDSCH transmissions). Additionally, DMRSs 305 may aid in demodulation of data symbols at the UE 115-b and facilitate channel estimation for coherent reception. In some examples, the UE 115-b may use one or more DMRSs 305 to estimate channel characteristics (e.g., amplitude and phase), which may aid in performing coherent demodulation in varying channel conditions. In some examples, a given DMRS 305 may be associated with a specific antenna port at the UE 115-b and mapped onto resource elements within a transmission grid (e.g., a grid that includes time and frequency resources). For instance, each DMRS port may correspond to a set of reference signals used for demodulation and channel estimation. As such, the network entity 105-a and UE 115-b may utilize DMRSs 305 in conjunction with data transmission on a PDSCH, where the UE 115-b may leverage DMRS 305 symbols to estimate channel conditions for the corresponding data symbols, which may increase accuracy associated with reception of the data transmission.

As described herein, the network entity 105-a may transmit one or more DMRSs 305 during a given time slot associated with a data transmission via a PDSCH. As such, the UE 115-b may determine to leverage a one or more DMRSs 305 from one or more prior time slots to perform channel estimation of a current slot. For example, if the network entity 105-a schedules the UE 115-b with multiple contiguous data transmissions (e.g., associated with respective time slots), the UE 115-b may leverage a DMRS 305 form a first slot that is prior to current slot to improve the channel estimation quality of the current slot. In some cases, the UE 115-b may leverage DMRSs 305 from previous slots if the previous slots are associated with a same precoder or TCI state as the current slot.

In some cases, however, the UE 115-b may be unable to leverage one or more DMRSs 305 for a current channel estimation. For example, due to Doppler shifting (e.g., when the UE 115-b is moving relative to the network entity 105-a) one or more prior DMRSs 305 may become outdated. Additionally, or alternatively, for multi-transmission and reception point (mTRP) operations a given PDSCH for a given TTI may be associated with multiple TCI state groups. As such, the PDSCH of a current time slot may be associated with a different TCI state group compared to one or more prior DMRSs 305. Additionally, or alternatively, a given DMRS 305 may include a set of DMRS tones (e.g., frequency tones) where a first subset of the DMRS tones may be associated with a first precoding resource group (PRG) corresponding to a first precoder and a second subset of the DMRS tones are associated with a second PRG corresponding to a second precoder. As such, if the PDSCH of the current slot is associated with the first precoder, the UE 115-b may be unable to leverage the second subset of DMRS tones associated with the second precoder. Additionally, or alternatively, different UEs 115 may vary in capability for leveraging DMRSs 305 from prior TTIs (e.g., a quantity of DMRSs 305, a UE 115-b buffer size to store information of previous DMRSs 305, etc.).

According to the techniques described herein, the network entity 105-a may indicate one or more portions of previous DMRSs 305 for the UE 115-b to use for performing a channel estimation of a current channel. For example, the UE 115-b may receive one or more DMRSs 305 during a first time interval. As such, the network entity 105-a may indicate to the UE 115-b to use the channel estimate information associated with the one or more DMRSs 305 for demodulating a data channel during a current time interval which occurs temporally after the first time interval.

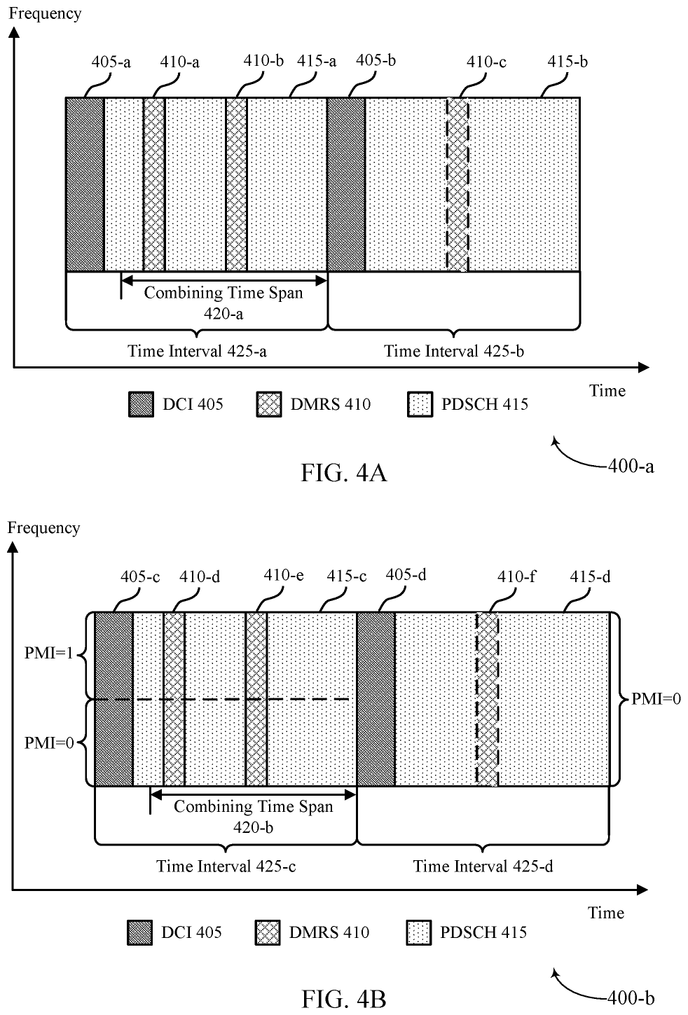

In some examples, the network entity 105-a may transmit one or more control messages 315 that indicate that the UE 115-b may leverage the DMRSs 305 included in a defined time span prior to the second time interval (e.g., a combining time span). Additionally, or alternatively, the network entity 105-a may indicate for a subset of DMRSs 305 from the one or more DMRSs 305 that correspond to a same TCI state group as the current time interval. Further discussion of leveraging prior DMRSs 305 in a defined combining time span based on TCI state group is described herein, including with reference to FIG. 4A.

Additionally, or alternatively, the one or more control messages 315 many indicate a subset of frequency tones across the one or more DMRSs 305 that correspond to a same precoder used for the PDSCH of the current time interval. Further discussion of leveraging prior DMRSs 305 based on precoders are described herein, including with reference to FIG. 4B. In some examples, the one or more control messages 315 may be one or more downlink control information (DCI) messages, one or more MAC-control element (MAC-CE) messages, one or more RRC messages, or a combination thereof.

Additionally, or alternatively, the UE 115-b may indicate a UE capability for leveraging pervious DMRSs 305. For example, the UE 115-b may transmit a DMRS capability message 315. In some examples, the DMRS capability message 315 may indicate threshold duration for which the UE 115-b may be capable of leveraging previous DMRSs 305 (e.g., a maximum duration of the combining time span). In some examples, the indication of the threshold duration may be in terms of a quantity of prior slots, a quantity of prior sub-slots, a quantity of prior TTIs, a quantity of prior resource elements, or a combination thereof. Additionally, or alternatively, the UE 115-b indicate one or more thresholds relative to a respective quantity of resources the UE 115-b may leverage from prior DMRSs 305. For instance, the UE 115-b may have a threshold for a quantity of DMRS 305 symbols (e.g., in the time domain), a threshold for a quantity of spatial layers, a threshold quantity of reception antennas, a threshold quantity of TCI groups, a threshold quantity of resource blocks of DMRSs 305 (e.g., in the frequency domain), a threshold quantity of prior channel estimates of DMRSs 305 (e.g., in the frequency domain). Additionally, or alternatively, the UE 115-b may indicate a storage capability (e.g., at a buffer of the UE 115-b) for storing DMRS 305 information, a capability for combining prior DMRSs 305, a capability fir combining prior channel estimates (e.g., in time, space, and frequency domains), or a combination thereof. Additionally, or alternatively, the UE 115-b may determine a threshold quantity of DMRSs 305 or channel estimation resource elements across the time domain, spatial domain, and the frequency domain. As such, the network entity 105-a may determine which prior DMRSs 305 or portions of prior DMRSs 305 to indicate in the one or more control messages 315 based on the information included by the UE 115-b in the DMRS capability message 310.

Based on receiving the one or more control messages 315, the UE 115-b may perform a channel estimate extrapolation procedure 320 for the current time interval. For example, the UE 115-b may leverage the information pertaining to the DMRSs 305 indicated in the one or more control messages 315 to extrapolate a channel estimation for the current time interval. In some examples, the UE 115-b may receive a DMRS 305 during the current time interval and use the extrapolated channel estimation in combination with channel estimation of the DMRS 305 of the current time interval. Such a combination may increase the quality of the channel estimation for the current time interval. In some examples, the network entity 105-a may refrain from transmitting a DMRS 305 during the current time interval, and as such, the UE 115-b may perform the channel estimation using the extrapolated channel estimates from the prior DMRSs 305. By refraining from transmitting a DMRS 305 for the current time interval, the network entity 105-a may reduce signal overhead of the wireless communications system 300.

In accordance with performing the channel estimate extrapolation procedure 320, the UE 115-b may receive a data transmission 325 via the PDSCH of the current time interval. For instance, the UE 115-b may perform a demodulation procedure 330 in which the UE 115-b demodulates the data transmission based on the channel estimation determined via the channel estimate extrapolation procedure 320.

FIGS. 4A and 4B each show a respective example of a DMRS extrapolation scheme 400 that supports reference signal extrapolation for channel estimation in accordance with one or more aspects of the present disclosure. Each of DMRS extrapolation scheme 400-a and 400-b may implement or may be implemented by aspects of the wireless communications system 100, network architecture 200, and wireless communications system 300. For example, the DMRS extrapolation scheme 400-a and 400-b may include operations performed by a UE 115 and a network entity 105 as described with reference to FIGS. 1 through 3. In accordance with FIGS. 4A and 4B, the UE 115 may receive one or more messages from the network entity 105 across one or more different time intervals 425. For instance, for a given time interval 425, the UE 115 may receive a one or more of a DCI 405, one or more DMRSs 410, and a data transmission via a PDSCH 415.

As illustrated in FIG. 4A, the UE 115 may receive one or more messages during a time interval 425-a and a time interval 425-b. In some examples, time interval 425-b may be a current time slot in which the UE 115 may perform channel estimation for to receive a data transmission, and time interval 425-a may be a prior time slot that the UE 115 performed a previous channel estimation for. While examples herein may refer to time intervals 425 as slots, it is understood that a given time interval 425 may refer to any duration of time including one or more slots, one or more sub-slots, one or more TTIs, one or more time resource elements, or a combination thereof. In some examples, during the prior time interval 425-a, the UE 115 may receive a DCI 405-a which may schedule the UE 115 for reception of one or more DMRSs 410 and a data transmission. For instance, the network entity 105 may schedule the UE 115 to receive DMRS 410-a, DMRS 410-b, or both during the time interval 425-a and receive a first data transmission via a PDSCH 415-a associated with the prior time interval 425-a.

According to the techniques described herein, the UE 115 may use information associated with one or more of DMRS 410-a and 410-b in performing channel estimation for the current time interval 425-b. For example, when the UE 115 receives multiple adjacent TTIs from the network entity 105, to estimate the channel in time interval 425-b for PDSCH 415-b decoding, the UE 115 may be able to utilize the DMRSs 410 transmitted by the network entity 105 in one or more previous slots when precoders are the same. In some cases, the UE 115 may perform the channel estimate extrapolation procedure 320 (e.g., with reference to FIG. 3) which may leverage one or more DMRS tones or one or more channel estimates associated with a combining time span 420. For example, with reference to FIG. 4A, the UE 115 may receive from the network entity 105 one or more control messages 315 (e.g., with reference to FIG. 3) that indicates the combining time span 420-a, which may be a time duration prior to the current time interval 425-b where one or more DMRS tones and/or one or more channel estimates are received and stored in buffer of the UE 115. As illustrated in FIG. 4A, DMRS 410-a and 410-b are each within the duration of the combining time span 420-a, and as such, the UE 115 may use one or more tones or channel estimates of DMRS 410-a and 410-b to extrapolate channel estimates for the current time interval 425-b. In some examples, the UE 115 may use information from DMRS 410-a, 410-b, or both, to extrapolate one or more channel estimates for symbols prior to a first DMRS 410 of time interval 425-b (e.g., prior to DMRS 410-c). In some examples, the UE 115 may use information from DMRS 410-a and 410-b in combination with DMRS 410-c to extrapolate (or interpolate) one or more channel estimates of time interval 425-b after reception of the DMRS 410-c. In some examples, the network entity 105 may refrain from transmitting DMRS 410-c to reduce signal overhead, and as such, the UE 115 may information from DMRS 410-a and 410-b to extrapolate channel estimates for symbols spanning across the duration of time interval 425-b.

In some cases, a given combining time span 420 (e.g., a duration of time that occurs prior to a current TTI or a current time slot) may be dynamically signaled (e.g., via DCI, via RRC, or both). In some examples, the network entity 105 may configure the UE 115 with the combining time span 420-a via an RRC message and transmit a DCI 405 to indicate whether to enable prior DMRS extrapolation. For instance, DCI 405-b may include such an indication, which enables the UE 115 to use the information of the prior DMRSs 410 for channel estimation of time interval 425-b. In some examples, the duration (e.g., length in time) of the combining time span 420-a may depend on a Doppler shift associated with the UE 115 (e.g., relative to the network entity 105), the buffer size of the UE 115 for storing information of prior DMRSs, or both. As such, the UE 115 may indicate such information (e.g., Doppler shirt, a buffer size of the UE, or both) via the DMRS capability message 310 (e.g., with reference to FIG. 3), and the network entity 105 may dynamically indicate the time interval 425-a via an RRC or DCI message based on the DMRS capability message 310.

In some cases of a single-DCI based mTRP operation, a given PDSCH 415 may be associated with one or two TCI states. In cases of two TCI states, DMRS ports may be grouped into two respective groups that are associated with different DMRS code division multiplexing (CDM) groups. For instance, with reference to PDSCH 415-a, the DMRS 410-a may be associated with a first group of DMRS ports corresponding to a first TCI state and the DMRS 410-b may be associated with a second group of DMRS ports corresponding to a second TCI state. Additionally, the quantity of TCI states associated with a given PDSCH 415 may change between respective TTIs. For instance, time interval 425-a may be associated with the two TCI states and time interval 425-b may be associated with a single TCI (e.g., the first TCI state or the second TCI state). As such, in addition to indicating the combining time span 420-a, the one or more control messages 315 may further indicate the DMRS resources suitable for DMRS extrapolation in terms of DMRS symbol and TCI state group. For example, the indication may indicate one or more DMRS symbol indexes within the combining time span 420-a (e.g., where each DMRS symbol may span one to two OFDM symbols). Additionally or alternatively, the indication may indicate a subset of DMRS ports or a TCI state group that the UE 115 may use for DMRS extrapolation. For instance, the network entity 105 may indicate to use the subset of DMRS ports that share a same TCI state with the current time interval 425-a. That is, if the DMRS 410-a is associated with the first TCI state, DMRS 410-b is associated with the second TCI state, and time interval 425-b is associated with the first TCI state, then the UE 115 may use the DMRS ports associated with DMRS 410-a for channel estimation during time interval 425-a. In some examples, such an indication of prior DMRS ports for use in extrapolation may be implicit, where the UE 115 may compare the TCI state of the current time interval 425-b to the TCI states of the prior DMRS ports. In some other examples, such an indication of prior DMRS ports for use in extrapolation may be explicit (e.g., via layer one signaling). For instance, the network entity 105 may indicate which prior DMRS ports to use via DCI 405-b of the current time interval 425-b.

As illustrated in FIG. 4B, the UE 115 may receive one or more messages during a time interval 425-c and a time interval 425-d. In some examples, time interval 425-d may be a current time slot where the UE 115 may perform channel estimation to receive a data transmission, and time interval 425-c may be a prior time slot that the UE 115 performed a previous channel estimation for. In some examples, during the prior time interval 425-c, the UE 115 may receive a DCI 405-c which may schedule the UE 115 for reception of one or more DMRSs 410 and a data transmission. For instance, the network entity 105 may schedule the UE 115 to receive DMRS 410-d, DMRS 410-e, or both during the time interval 425-c and receive a first data transmission via a PDSCH 415-c associated with the time interval 425-c.

In some examples, one or more different precoders may be used across the different time intervals 425. For instance, time interval 425-c may be associated with a first precoder corresponding to precoding matrix indicator (PMI) 0 that spans a first set of frequency tones of PDSCH 415-c and a second precoder corresponding to PMI 1 that spans a second set of frequency tones of PDSCH 415-c. While FIG. 4B illustrates the first set of frequency tones of PMI 0 and the second set of frequency tones of PMI 1 as contiguous in the frequency domain, it is understood that the frequency tones of PMI 0 and PMI 1 may be interlaced in accordance with a frequency comb structure. Additionally, as illustrated in FIG. 4B, the frequency tones of PDSCH 415-d may each be associated with the first precoder corresponding to PMI 0.

According to the techniques described herein, the UE 115 may use the frequency tones of the prior DMRSs within combining time span 420-b to extrapolate channel estimation for the current time interval 425-d. For example, the network entity 105 and UE 115 may partition the first set of frequency tones (e.g., associated with PMI 0) into a first set of precoding resource groups (PRGs) and the second set of frequency tones (e.g., associated with PMI 1) into a second set of PRGs. As such, the network entity 105 may use a bitmap in a DCI (e.g., DCI 405-d) to indicate a precoder change between time interval 425-c and time interval 425-d. In some examples, the bitmap may include a bit value for each PRG of the first and second set of PRGs, where if the PRGs are of a first value, the UE 115 may determine to use such associated frequency tones to perform DMRS extrapolation. In examples where the first set of PRGs associated with PMI 0 and the second set of PRGs associated with PMI 1 are respectively contiguous in the frequency domain, the bitmap may include a first bit value for the first set of PRGs and a second bit value for the second set of PRGs.

As illustrated in FIG. 4B, DMRS 410-d and 410-e are each within the duration of the combining time span 420-b, and as such, the UE 115 may use the frequency tones or channel estimates of DMRS 410-d and 410-e associated with PMI 0 to extrapolate channel estimates for time interval 425-d. In some examples, the UE 115 may use information from DMRS 410-d and 410-e to extrapolate channel estimates for symbols prior to a first DMRS of time interval 425-d (e.g., prior to DMRS 410-f). In some examples, the UE 115 may use information from DMRS 410-d and 410-e in combination with DMRS 410-f to extrapolate channel estimates of time interval 425-d after reception of the DMRS 410-f. In some examples, the network entity 105 may refrain from transmitting DMRS 410-f to reduce signal overhead, and as such, the UE 115 may use information from DMRS 410-d and 410-e to extrapolate channel estimates for symbols spanning across the duration of time interval 425-d.

Additionally, or alternatively, the network entity 105 and UE 115 may use the techniques of FIGS. 4A and 4B separately or in combination. For instance, the network entity 105 may indicate one or more of a combining time span 420, a set of prior DMRS ports associated with a TCI state of the current time interval 425, and a set of frequency tones of the prior DMRSs associated with a precoder of the current time interval 425. Additionally, or alternatively, the combining time span 420 may span multiple previous slots or TTIs prior to the current time interval 425. In some examples, the combining time span 420 may begin from the start of the current time interval 425 such that one or more previous slots or TTIs are directly prior to the current time interval 425. In some examples, the combining time span may begin prior to the start of the current time interval 425, such that the one or more previous slots or TTIs may not be directly prior to the current time interval 425.

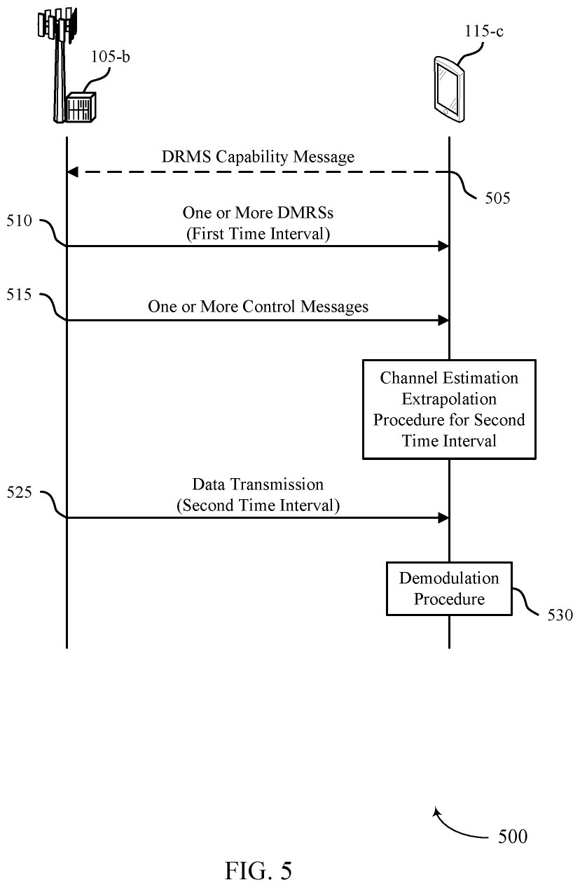

FIG. 5 shows an example of a process flow 500 that supports reference signal extrapolation for channel estimation in accordance with one or more aspects of the present disclosure. In some examples, process flow 500 may implement aspects of wireless communications system 100, network architecture 200, and wireless communications system 300, and DMRS extrapolation scheme 400-a and 400-b. Process flow 500 may include a UE 115-c and a network entity 105-b, as described with reference to FIGS. 1 through 4B. Alternative examples of the following may be implemented, where some steps are performed in a different order than described or are not performed at all. In some cases, steps may include additional features not mentioned below, or further steps may be added. In addition, it is understood that these processes may occur between any quantity of network devices and network device types.

At 505, the UE 115-c may transmit to the network entity 105-b a capability message that indicates one or more parameters associated with using one or more previous DMRSs to perform channel estimation for PDSCH demodulation (e.g., DMRS capability message 310, with reference to FIG. 3). In some examples, the one or more parameters may include a maximum time span prior to the second time interval, a quantity of one or more prior DMRS symbols, a quantity of one or more spatial layers, a quantity of one or more antennas at the UE 115-c, a quantity of one or more TCI state groups, a quantity of one or more prior DMRS resource blocks, a capability of the UE 115-c for storing temporal information associated with DMRSs, a capability of the UE 115-c for storing spatial information associated with DMRSs, and a capability of the UE 115-c for storing frequency information associated with DMRSs, or a combination thereof. In some examples, the one or more parameters may include a maximum time span prior to the second time interval, a quantity of DMRS resource elements across a temporal domain, a frequency domain, and a spatial domain, or a combination thereof.

At 510, the UE 115-c may receive from the network entity 105-b one or more DMRSs during a first time interval. In some examples, the channel estimate information associated with the one or more DMRSs may include a respective set of DMRS tones associated with a respective DMRS of the one or more DMRSs, a respective channel estimate associated with a respective DMRS of the one or more DMRSs, or both. In some examples, the channel estimate information is stored at a buffer of the UE 115-c.

At 515, the UE 115-c may receive from the network entity 105-b one or more control messages indicating for the UE 115-c to use channel estimate information associated with the one or more DMRSs received during the first time interval for demodulating a PDSCH during a second time interval, where the second time interval occurs temporally after the first time interval.

In some examples, the UE 115-c may receive, as part of the one or more control messages, an indication of a time span prior to the second time interval that defines a duration of the first time interval, where the one or more DMRSs included in the first time interval may be based on the time span indicated in the one or more control messages. In some examples the one or more control messages may be received based on the capability message. For instance, a duration of the time span is based on doppler information associated with the PDSCH, a buffer storage size of the UE 115-c, or both.

In some examples, a first control message of the one or more control messages may indicate the time span of the first time interval and a second control message may indicate for the UE 115-c to use the channel estimate information associated with the one or more DMRSs received during the first time interval for demodulating a PDSCH.

In some cases, a first set of DMRSs are associated with a first set of DMRS symbols and a first TCI state group, and a second set of DMRSs are associated with a second set of DMRS symbols and a second TCI state group. In a first example, the first set of DMRSs may include the one or more DMRSs received during the first time interval. As such, the UE 115-c may receive as part of the one or more control messages, an indication of a DMRS symbol index that indicates the first set of DMRS symbols associated with the first set of DMRSs, where the channel estimate information is based on the first set of DMRSs. In a second example, the first set of DMRSs may include the one or more DMRSs received during the first time interval, where the PDSCH associated with the second time interval is associated with the first TCI state group. As such, the UE 115-c may receive, as part of the one or more control messages, an indication for the UE 115-c to use the channel estimate information associated with the first set of DMRSs for demodulating the PDSCH based on the first set of DMRSs and the PDSCH being associated with the first TCI state group.

In some cases, a first set of DMRS tones may be associated with a first set of PRGs associated with a first precoder, and a second set of DMRS tones is associated with a second set of PRGs associated with a second precoder. In some examples, the first set of DMRS tones corresponds to the one or more DMRSs received during the first time interval, and the PDSCH associated with the second time interval may be associated with the first precoder. As such, the UE 115-c may receive, as part of the one or more control messages, an indication for the UE 115-c to use the channel estimate information associated with the first set of DMRS tones for demodulating the PDSCH based on the first set of DMRS tones and the PDSCH being associated with the first precoder. In a first example, the indication for the UE 115-c to use the channel estimate information associated with the first set of DMRS tones includes an indication of each PRG of the first set of PRGs associated with the first precoder. In a second example, the indication for the UE 115-c to use the channel estimate information associated with the first set of DMRS tones includes a bit map, where each bit of the bit map may be associated with a respective PRG included within the one or more DMRSs, and each bit of the bit map associated with a PRG of the first set of PRGs may be set to a first value that indicates for the UE 115-c to use the channel estimate information associated with the first set of PRGs. In a third example, the first set of PRGs may be contiguous across a first set of frequency resources and the second set of PRGs are contiguous across a second set of frequency resources, where the indication for the UE 115-c to use the channel estimate information associated with the first set of DMRS tones includes a bit map, and a first bit of the bit map may be associated with the first set of PRGs and set to a first value that indicates for the UE 115-c to use the channel estimate information associated with the first set of PRGs.

At 520, the UE 115-c may perform a channel estimation extrapolation procedure for the second time interval. For example, the UE 115-c may generate a channel estimate of the PDSCH for the second time interval based on the channel estimate information associated with the one or more DMRSs received during the first time interval.

At 525, the UE 115-c may receive from the network entity 105-b a data transmission via a PDSCH of the second time interval.

At 530, the UE 115-c may demodulate, via the PDSCH, the data transmission based on the channel estimate information.

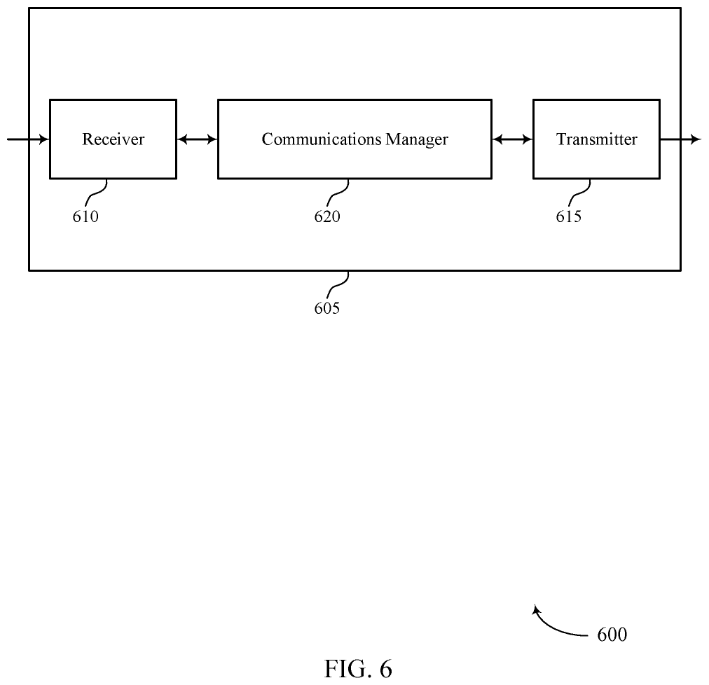

FIG. 6 shows a block diagram 600 of a device 605 that supports reference signal extrapolation for channel estimation in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to reference signal extrapolation for channel estimation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to reference signal extrapolation for channel estimation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of reference signal extrapolation for channel estimation as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving one or more DMRSs during a first time interval. The communications manager 620 is capable of, configured to, or operable to support a means for receiving one or more control messages indicating for the UE to use channel estimate information associated with the one or more DMRSs received during the first time interval for demodulating a data channel during a second time interval, where the second time interval occurs temporally after the first time interval. The communications manager 620 is capable of, configured to, or operable to support a means for demodulating, via the data channel, a data transmission based on the channel estimate information.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

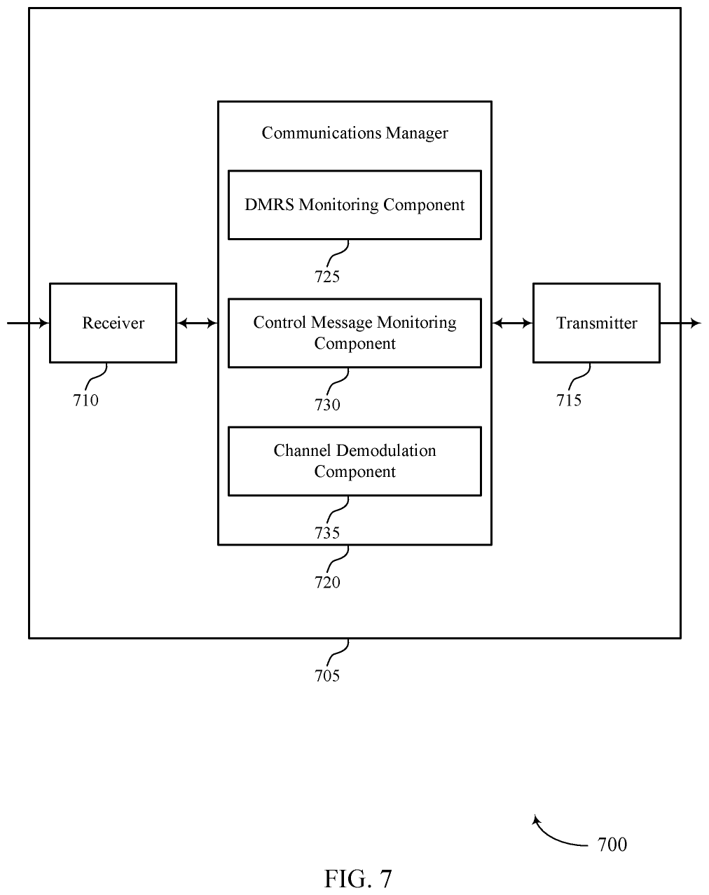

FIG. 7 shows a block diagram 700 of a device 705 that supports reference signal extrapolation for channel estimation in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to reference signal extrapolation for channel estimation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to reference signal extrapolation for channel estimation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of reference signal extrapolation for channel estimation as described herein. For example, the communications manager 720 may include a DMRS monitoring component 725, a control message monitoring component 730, a channel demodulation component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The DMRS monitoring component 725 is capable of, configured to, or operable to support a means for receiving one or more DMRSs during a first time interval. The control message monitoring component 730 is capable of, configured to, or operable to support a means for receiving one or more control messages indicating for the UE to use channel estimate information associated with the one or more DMRSs received during the first time interval for demodulating a data channel during a second time interval, where the second time interval occurs temporally after the first time interval. The channel demodulation component 735 is capable of, configured to, or operable to support a means for demodulating, via the data channel, a data transmission based on the channel estimate information.

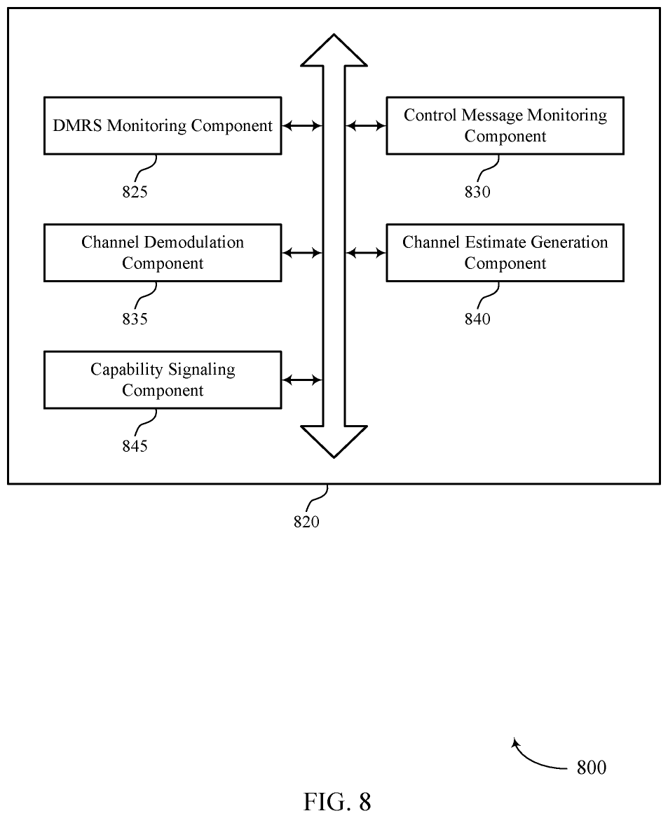

FIG. 8 shows a block diagram 800 of a communications manager 820 that supports reference signal extrapolation for channel estimation in accordance with one or more aspects of the present disclosure. The communications manager 820 may be an example of aspects of a communications manager 620, a communications manager 720, or both, as described herein. The communications manager 820, or various components thereof, may be an example of means for performing various aspects of reference signal extrapolation for channel estimation as described herein. For example, the communications manager 820 may include a DMRS monitoring component 825, a control message monitoring component 830, a channel demodulation component 835, a channel estimate generation component 840, a capability signaling component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The DMRS monitoring component 825 is capable of, configured to, or operable to support a means for receiving one or more DMRSs during a first time interval. The control message monitoring component 830 is capable of, configured to, or operable to support a means for receiving one or more control messages indicating for the UE to use channel estimate information associated with the one or more DMRSs received during the first time interval for demodulating a data channel during a second time interval, where the second time interval occurs temporally after the first time interval. The channel demodulation component 835 is capable of, configured to, or operable to support a means for demodulating, via the data channel, a data transmission based on the channel estimate information.

In some examples, the channel estimate generation component 840 is capable of, configured to, or operable to support a means for generating a channel estimate of the data channel for the second time interval based on the channel estimate information associated with the one or more DMRSs received during the first time interval, where demodulating the data transmission is based on the channel estimate.

In some examples, the control message monitoring component 830 is capable of, configured to, or operable to support a means for receiving, as part of the one or more control messages, an indication of a time span prior to the second time interval that defines a duration of the first time interval, where the one or more DMRSs included in the first time interval are based on the time span indicated in the one or more control messages.

In some examples, a first control message of the one or more control messages indicates the time span of the first time interval and a second control message of the one or more control messages indicates for the UE to use the channel estimate information associated with the one or more DMRSs received during the first time interval for demodulating the data channel.

In some examples, a duration of the time span is based on doppler information associated with the data channel, a buffer storage size of the UE, or both.

In some examples, a first set of DMRSs are associated with a first set of DMRS symbols and a first TCI state group. In some examples, a second set of DMRSs are associated with a second set of DMRS symbols and a second TCI state group.

In some examples, the first set of DMRSs includes the one or more DMRSs received during the first time interval, and the control message monitoring component 830 is capable of, configured to, or operable to support a means for receiving, as part of the one or more control messages, an indication of a DMRS symbol index that indicates the first set of DMRS symbols associated with the first set of DMRSs, where the channel estimate information is based on the first set of DMRSs.

In some examples, the first set of DMRSs includes the one or more DMRSs received during the first time interval, and the control message monitoring component 830 is capable of, configured to, or operable to support a means for receiving, as part of the one or more control messages, an indication for the UE to use the channel estimate information associated with the first set of DMRSs for demodulating the data channel based on the first set of DMRSs and the data channel being associated with the first TCI state group.

In some examples, a first set of DMRS tones is associated with a first set of PRGs associated with a first precoder. In some examples, a second set of DMRS tones is associated with a second set of PRGs associated with a second precoder.

In some examples, the first set of DMRS tones corresponds to the one or more DMRSs received during the first time interval, and the control message monitoring component 830 is capable of, configured to, or operable to support a means for receiving, as part of the one or more control messages, an indication for the UE to use the channel estimate information associated with the first set of DMRS tones for demodulating the data channel based on the first set of DMRS tones and the data channel being associated with the first precoder.

In some examples, the indication for the UE to use the channel estimate information associated with the first set of DMRS tones includes an indication of each PRG of the first set of PRGs associated with the first precoder.

In some examples, the indication for the UE to use the channel estimate information associated with the first set of DMRS tones includes a bit map. In some examples, each bit of the bit map is associated with a respective PRG included within the one or more DMRSs. In some examples, each bit of the bit map associated with a PRG of the first set of PRGs is set to a first value that indicates for the UE to use the channel estimate information associated with the first set of PRGs.

In some examples, the first set of PRGs are contiguous across a first set of frequency resources and the second set of PRGs are contiguous across a second set of frequency resources. In some examples, the indication for the UE to use the channel estimate information associated with the first set of DMRS tones includes a bit map. In some examples, a first bit of the bit map is associated with the first set of PRGs and set to a first value that indicates for the UE to use the channel estimate information associated with the first set of PRGs.

In some examples, the capability signaling component 845 is capable of, configured to, or operable to support a means for transmitting a capability message that indicates one or more parameters associated with using one or more previous DMRSs to perform channel estimation for data channel demodulation, where the one or more control messages is received based on the capability message.

In some examples, the one or more parameters include a maximum time span prior to the second time interval, a quantity of one or more prior DMRS symbols, a quantity of one or more spatial layers, a quantity of one or more antennas at the UE, a quantity of one or more TCI groups, a quantity of one or more prior DMRS resource blocks, a capability of the UE for storing temporal information associated with DMRSs, a capability of the UE for storing spatial information associated with DMRSs, and a capability of the UE for storing frequency information associated with DMRSs, or a combination thereof.

In some examples, the one or more parameters include a maximum time span prior to the second time interval, a quantity of DMRS resource elements across a temporal domain, a frequency domain, and a spatial domain, or a combination thereof.

In some examples, the channel estimate information associated with the one or more DMRSs includes a respective set of DMRS tones associated with a respective DMRS of the one or more DMRSs, a respective channel estimate associated with a respective DMRS of the one or more DMRSs, or both. In some examples, the channel estimate information is stored at a buffer of the UE.

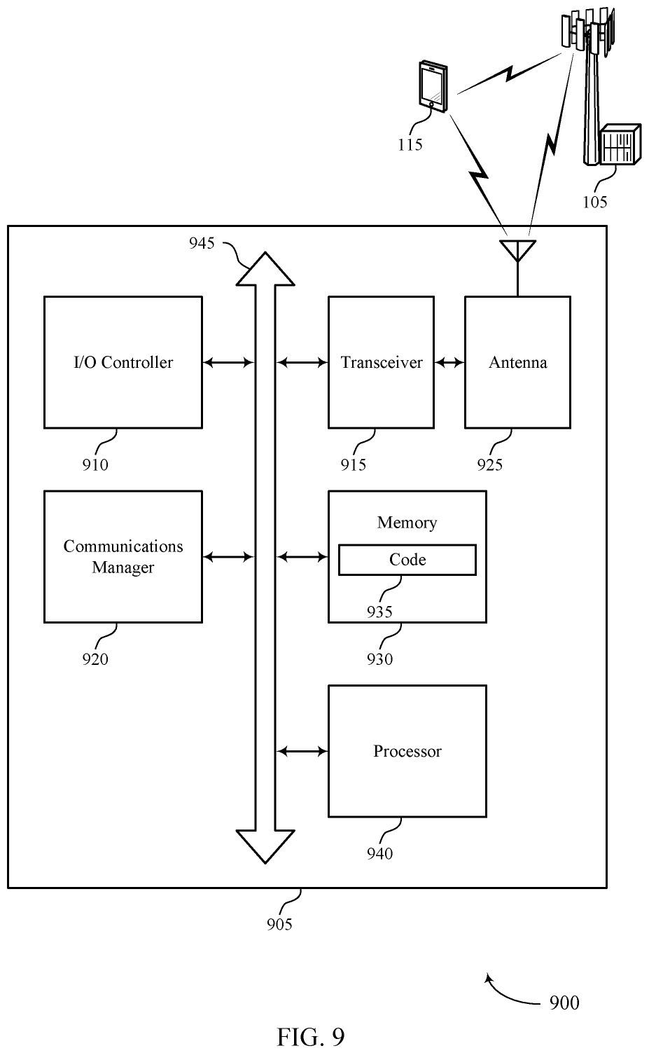

FIG. 9 shows a diagram of a system 900 including a device 905 that supports reference signal extrapolation for channel estimation in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting reference signal extrapolation for channel estimation). For example, the device 905 or a component of the device 905 may include at least one processor 940 and at least one memory 930 coupled with or to the at least one processor 940, the at least one processor 940 and the at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving one or more DMRSs during a first time interval. The communications manager 920 is capable of, configured to, or operable to support a means for receiving one or more control messages indicating for the UE to use channel estimate information associated with the one or more DMRSs received during the first time interval for demodulating a data channel during a second time interval, where the second time interval occurs temporally after the first time interval. The communications manager 920 is capable of, configured to, or operable to support a means for demodulating, via the data channel, a data transmission based on the channel estimate information.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of reference signal extrapolation for channel estimation as described herein, or the at least one processor 940 and the at least one memory 930 may be otherwise configured to, individually or collectively, perform or support such operations.

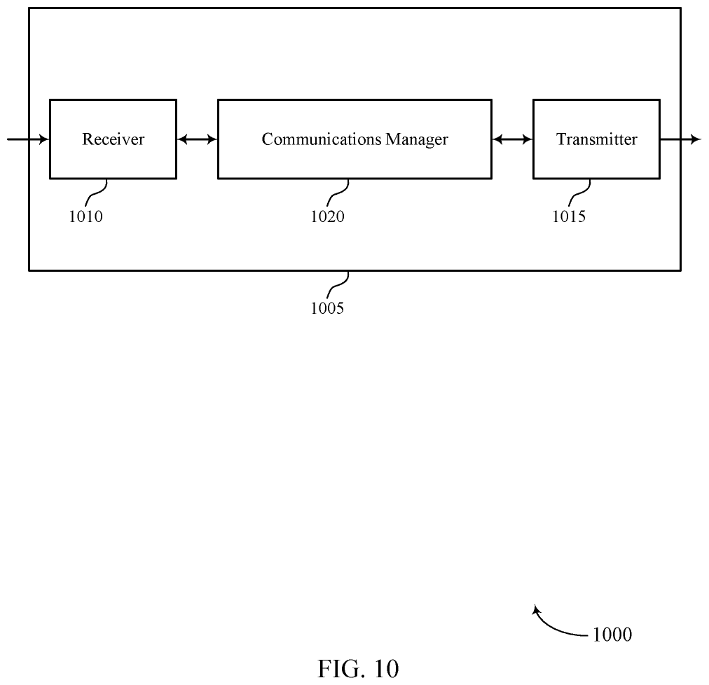

FIG. 10 shows a block diagram 1000 of a device 1005 that supports reference signal extrapolation for channel estimation in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of reference signal extrapolation for channel estimation as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting one or more DMRSs during a first time interval. The communications manager 1020 is capable of, configured to, or operable to support a means for outputting one or more control messages indicating for a UE to use channel estimate information associated with the one or more DMRSs transmitted during the first time interval for demodulating a data channel during a second time interval, where the second time interval occurs temporally after the first time interval. The communications manager 1020 is capable of, configured to, or operable to support a means for outputting, via the data channel, a data transmission.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

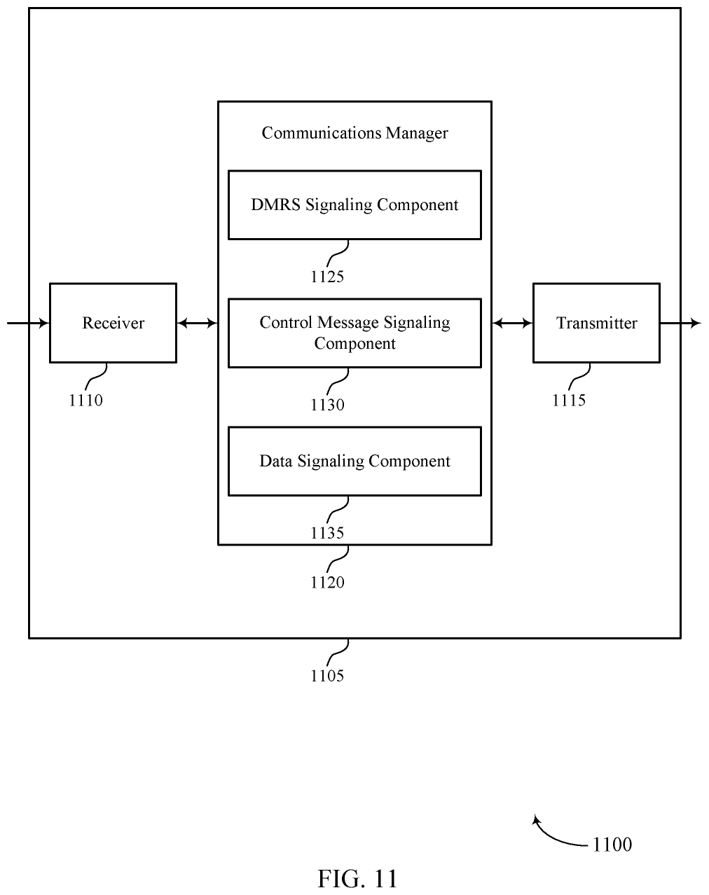

FIG. 11 shows a block diagram 1100 of a device 1105 that supports reference signal extrapolation for channel estimation in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of reference signal extrapolation for channel estimation as described herein. For example, the communications manager 1120 may include a DMRS signaling component 1125, a control message signaling component 1130, a data signaling component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The DMRS signaling component 1125 is capable of, configured to, or operable to support a means for outputting one or more DMRSs during a first time interval. The control message signaling component 1130 is capable of, configured to, or operable to support a means for outputting one or more control messages indicating for a UE to use channel estimate information associated with the one or more DMRSs transmitted during the first time interval for demodulating a data channel during a second time interval, where the second time interval occurs temporally after the first time interval. The data signaling component 1135 is capable of, configured to, or operable to support a means for outputting, via the data channel, a data transmission.

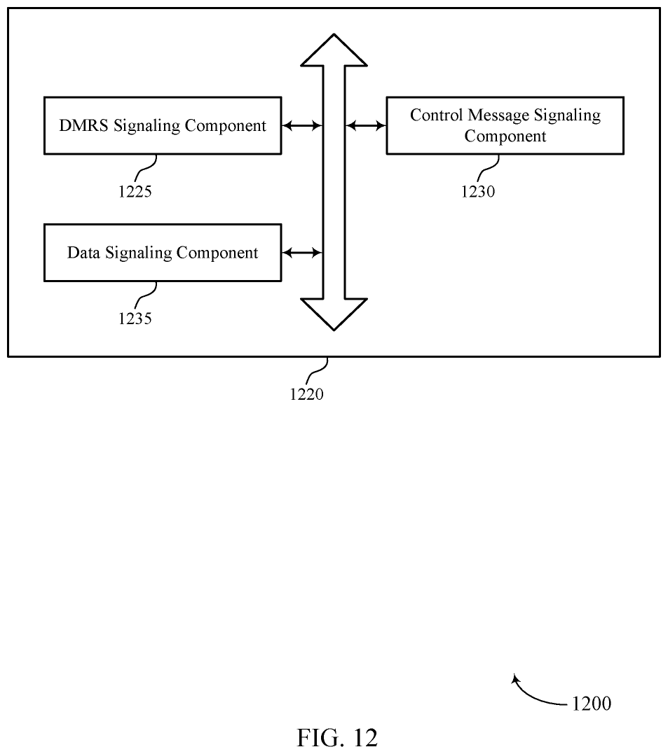

FIG. 12 shows a block diagram 1200 of a communications manager 1220 that supports reference signal extrapolation for channel estimation in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of reference signal extrapolation for channel estimation as described herein. For example, the communications manager 1220 may include a DMRS signaling component 1225, a control message signaling component 1230, a data signaling component 1235, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The DMRS signaling component 1225 is capable of, configured to, or operable to support a means for outputting one or more DMRSs during a first time interval. The control message signaling component 1230 is capable of, configured to, or operable to support a means for outputting one or more control messages indicating for a UE to use channel estimate information associated with the one or more DMRSs transmitted during the first time interval for demodulating a data channel during a second time interval, where the second time interval occurs temporally after the first time interval. The data signaling component 1235 is capable of, configured to, or operable to support a means for outputting, via the data channel, a data transmission.

In some examples, the control message signaling component 1230 is capable of, configured to, or operable to support a means for outputting, as part of the one or more control messages, an indication of a time span prior to the second time interval that defines a duration of the first time interval, where the one or more DMRSs included in the first time interval are based on the time span indicated in the one or more control messages.

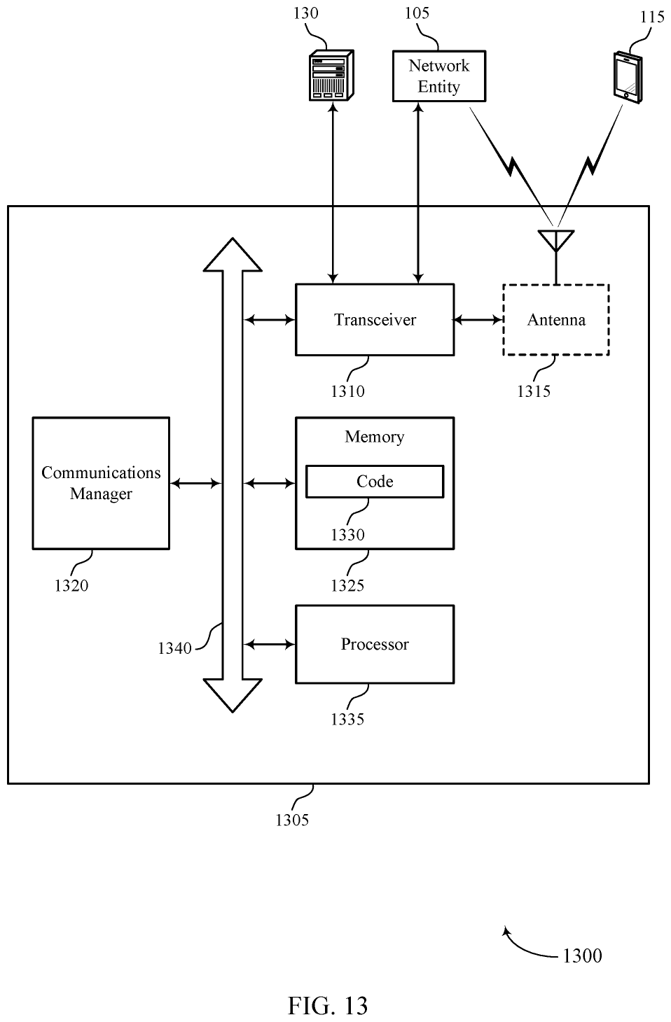

FIG. 13 shows a diagram of a system 1300 including a device 1305 that supports reference signal extrapolation for channel estimation in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting reference signal extrapolation for channel estimation). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network devices 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting one or more DMRSs during a first time interval. The communications manager 1320 is capable of, configured to, or operable to support a means for outputting one or more control messages indicating for a UE to use channel estimate information associated with the one or more DMRSs transmitted during the first time interval for demodulating a data channel during a second time interval, where the second time interval occurs temporally after the first time interval. The communications manager 1320 is capable of, configured to, or operable to support a means for outputting, via the data channel, a data transmission.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of reference signal extrapolation for channel estimation as described herein, or the at least one processor 1335 and the at least one memory 1325 may be otherwise configured to, individually or collectively, perform or support such operations.

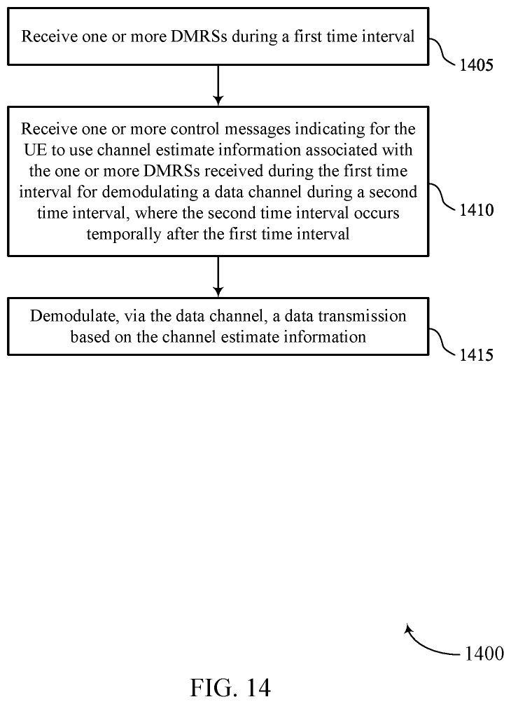

FIG. 14 shows a flowchart illustrating a method 1400 that supports reference signal extrapolation for channel estimation in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving one or more DMRSs during a first time interval. The operations of 1405 may be performed in accordance with examples as disclosed herein. In some examples, aspects of the operations of 1405 may be performed by a DMRS monitoring component 825 as described with reference to FIG. 8.

At 1410, the method may include receiving one or more control messages indicating for the UE to use channel estimate information associated with the one or more DMRSs received during the first time interval for demodulating a data channel during a second time interval, where the second time interval occurs temporally after the first time interval. The operations of 1410 may be performed in accordance with examples as disclosed herein. In some examples, aspects of the operations of 1410 may be performed by a control message monitoring component 830 as described with reference to FIG. 8.

At 1415, the method may include demodulating, via the data channel, a data transmission based on the channel estimate information. The operations of 1415 may be performed in accordance with examples as disclosed herein. In some examples, aspects of the operations of 1415 may be performed by a channel demodulation component 835 as described with reference to FIG. 8.

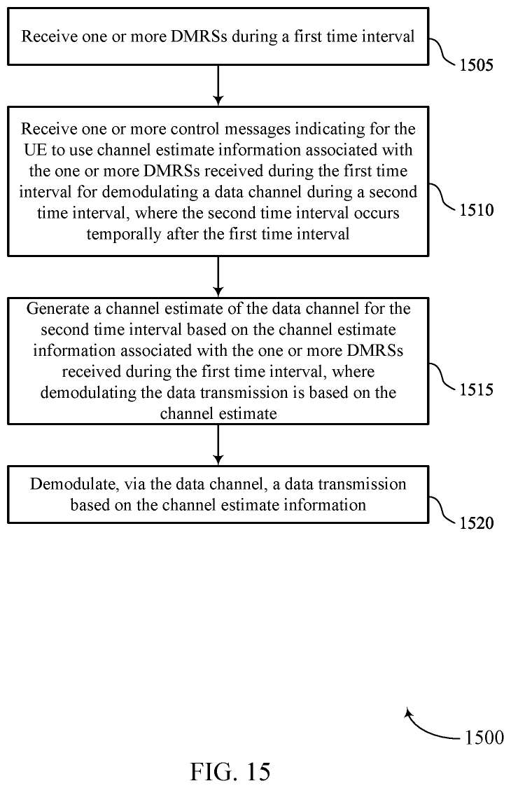

FIG. 15 shows a flowchart illustrating a method 1500 that supports reference signal extrapolation for channel estimation in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving one or more DMRSs during a first time interval. The operations of 1505 may be performed in accordance with examples as disclosed herein. In some examples, aspects of the operations of 1505 may be performed by a DMRS monitoring component 825 as described with reference to FIG. 8.

At 1510, the method may include receiving one or more control messages indicating for the UE to use channel estimate information associated with the one or more DMRSs received during the first time interval for demodulating a data channel during a second time interval, where the second time interval occurs temporally after the first time interval. The operations of 1510 may be performed in accordance with examples as disclosed herein. In some examples, aspects of the operations of 1510 may be performed by a control message monitoring component 830 as described with reference to FIG. 8.

At 1515, the method may include generating a channel estimate of the data channel for the second time interval based on the channel estimate information associated with the one or more DMRSs received during the first time interval, where demodulating the data transmission is based on the channel estimate. The operations of 1515 may be performed in accordance with examples as disclosed herein. In some examples, aspects of the operations of 1515 may be performed by a channel estimate generation component 840 as described with reference to FIG. 8.

At 1520, the method may include demodulating, via the data channel, a data transmission based on the channel estimate information. The operations of 1520 may be performed in accordance with examples as disclosed herein. In some examples, aspects of the operations of 1520 may be performed by a channel demodulation component 835 as described with reference to FIG. 8.

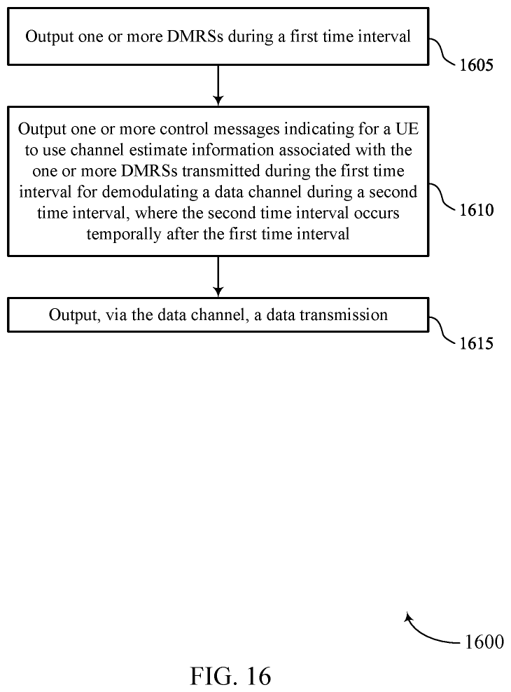

FIG. 16 shows a flowchart illustrating a method 1600 that supports reference signal extrapolation for channel estimation in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting one or more DMRSs during a first time interval. The operations of 1605 may be performed in accordance with examples as disclosed herein. In some examples, aspects of the operations of 1605 may be performed by a DMRS signaling component 1225 as described with reference to FIG. 12.

At 1610, the method may include outputting one or more control messages indicating for a UE to use channel estimate information associated with the one or more DMRSs transmitted during the first time interval for demodulating a data channel during a second time interval, where the second time interval occurs temporally after the first time interval. The operations of 1610 may be performed in accordance with examples as disclosed herein. In some examples, aspects of the operations of 1610 may be performed by a control message signaling component 1230 as described with reference to FIG. 12.

At 1615, the method may include outputting, via the data channel, a data transmission. The operations of 1615 may be performed in accordance with examples as disclosed herein. In some examples, aspects of the operations of 1615 may be performed by a data signaling component 1235 as described with reference to FIG. 12.

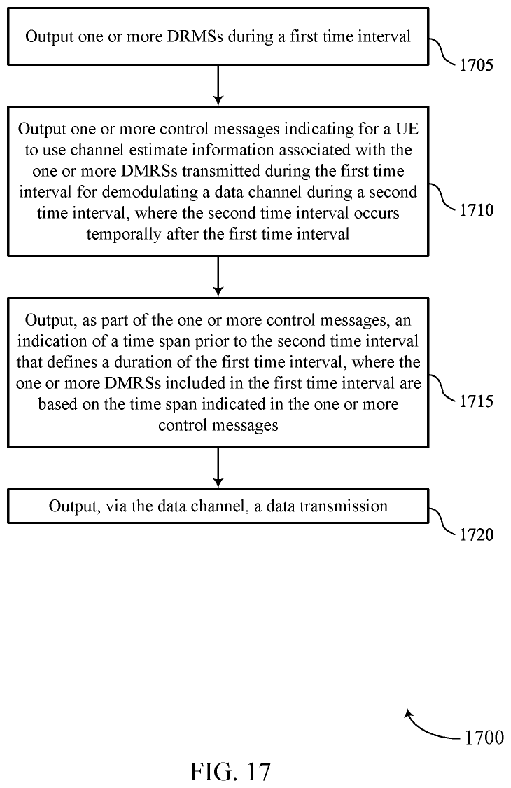

FIG. 17 shows a flowchart illustrating a method 1700 that supports reference signal extrapolation for channel estimation in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting one or more DMRSs during a first time interval. The operations of 1705 may be performed in accordance with examples as disclosed herein. In some examples, aspects of the operations of 1705 may be performed by a DMRS signaling component 1225 as described with reference to FIG. 12.

At 1710, the method may include outputting one or more control messages indicating for a UE to use channel estimate information associated with the one or more DMRSs transmitted during the first time interval for demodulating a data channel during a second time interval, where the second time interval occurs temporally after the first time interval. The operations of 1710 may be performed in accordance with examples as disclosed herein. In some examples, aspects of the operations of 1710 may be performed by a control message signaling component 1230 as described with reference to FIG. 12.

At 1715, the method may include outputting, as part of the one or more control messages, an indication of a time span prior to the second time interval that defines a duration of the first time interval, where the one or more DMRSs included in the first time interval are based on the time span indicated in the one or more control messages. The operations of 1715 may be performed in accordance with examples as disclosed herein. In some examples, aspects of the operations of 1715 may be performed by a control message signaling component 1230 as described with reference to FIG. 12.

At 1720, the method may include outputting, via the data channel, a data transmission. The operations of 1720 may be performed in accordance with examples as disclosed herein. In some examples, aspects of the operations of 1720 may be performed by a data signaling component 1235 as described with reference to FIG. 12.

The following provides an overview of aspects of the present disclosure:

Aspect 1: A method for wireless communications, at a UE, comprising: receiving one or more DMRSs during a first time interval; receiving one or more control messages indicating for the UE to use channel estimate information associated with the one or more DMRSs received during the first time interval for demodulating a data channel during a second time interval, wherein the second time interval occurs temporally after the first time interval; and demodulating, via the data channel, a data transmission based at least in part on the channel estimate information.

Aspect 2: The method of aspect 1, further comprising: generating a channel estimate of the data channel for the second time interval based at least in part on the channel estimate information associated with the one or more DMRSs received during the first time interval, wherein demodulating the data transmission is based at least in part on the channel estimate.

Aspect 3: The method of any of aspects 1 through 2, further comprising: receiving, as part of the one or more control messages, an indication of a time span prior to the second time interval that defines a duration of the first time interval, wherein the one or more DMRSs comprised in the first time interval are based at least in part on the time span indicated in the one or more control messages.

Aspect 4: The method of aspect 3, wherein a first control message of the one or more control messages indicates the time span of the first time interval and a second control message of the one or more control messages indicates for the UE to use the channel estimate information associated with the one or more DMRSs received during the first time interval for demodulating the data channel.

Aspect 5: The method of any of aspects 3 through 4, wherein a duration of the time span is based at least in part on doppler information associated with the data channel, a buffer storage size of the UE, or both.

Aspect 6: The method of any of aspects 1 through 5, wherein a first set of DMRSs are associated with a first set of DMRS symbols and a first TCI state group, and a second set of DMRSs are associated with a second set of DMRS symbols and a second TCI state group.

Aspect 7: The method of aspect 6, wherein the first set of DMRSs comprises the one or more DMRSs received during the first time interval, the method further comprising: receiving, as part of the one or more control messages, an indication of a DMRS symbol index that indicates the first set of DMRS symbols associated with the first set of DMRSs, wherein the channel estimate information is based at least in part on the first set of DMRSs.

Aspect 8: The method of any of aspects 6 through 7, wherein the first set of DMRSs comprises the one or more DMRSs received during the first time interval, and wherein the data channel associated with the second time interval is associated with the first TCI state group, the method further comprising: receiving, as part of the one or more control messages, an indication for the UE to use the channel estimate information associated with the first set of DMRSs for demodulating the data channel based at least in part on the first set of DMRSs and the data channel being associated with the first TCI state group.

Aspect 9: The method of any of aspects 1 through 8, wherein a first set of DMRS tones is associated with a first set of PRGs associated with a first precoder, and a second set of DMRS tones is associated with a second set of PRGs associated with a second precoder.

Aspect 10: The method of aspect 9, wherein the first set of DMRS tones corresponds to the one or more DMRSs received during the first time interval, and wherein the data channel associated with the second time interval is associated with the first precoder, the method further comprising: receiving, as part of the one or more control messages, an indication for the UE to use the channel estimate information associated with the first set of DMRS tones for demodulating the data channel based at least in part on the first set of DMRS tones and the data channel being associated with the first precoder.

Aspect 11: The method of aspect 10, wherein the indication for the UE to use the channel estimate information associated with the first set of DMRS tones comprises an indication of each PRG of the first set of PRGs associated with the first precoder.

Aspect 12: The method of any of aspects 10 through 11, wherein the indication for the UE to use the channel estimate information associated with the first set of DMRS tones comprises a bit map, each bit of the bit map is associated with a respective PRG comprised within the one or more DMRSs, and each bit of the bit map associated with a PRG of the first set of PRGs is set to a first value that indicates for the UE to use the channel estimate information associated with the first set of PRGs.

Aspect 13: The method of any of aspects 10 through 12, wherein the first set of PRGs are contiguous across a first set of frequency resources and the second set of PRGs are contiguous across a second set of frequency resources, the indication for the UE to use the channel estimate information associated with the first set of DMRS tones comprises a bit map, and a first bit of the bit map is associated with the first set of PRGs and set to a first value that indicates for the UE to use the channel estimate information associated with the first set of PRGs.

Aspect 14: The method of any of aspects 1 through 13, further comprising: transmitting a capability message that indicates one or more parameters associated with using one or more previous DMRSs to perform channel estimation for data channel demodulation, wherein the one or more control messages is received based at least in part on the capability message.

Aspect 15: The method of aspect 14, wherein the one or more parameters comprise a maximum time span prior to the second time interval, a quantity of one or more prior DMRS symbols, a quantity of one or more spatial layers, a quantity of one or more antennas at the UE, a quantity of one or more TCI groups, a quantity of one or more prior DMRS resource blocks, a capability of the UE for storing temporal information associated with DMRSs, a capability of the UE for storing spatial information associated with DMRSs, and a capability of the UE for storing frequency information associated with DMRSs, or a combination thereof.

Aspect 16: The method of any of aspects 14 through 15, wherein the one or more parameters comprise a maximum time span prior to the second time interval, a quantity of DMRS resource elements across a temporal domain, a frequency domain, and a spatial domain, or a combination thereof.

Aspect 17: The method of any of aspects 1 through 16, wherein the channel estimate information associated with the one or more DMRSs comprises a respective set of DMRS tones associated with a respective DMRS of the one or more DMRSs, a respective channel estimate associated with a respective DMRS of the one or more DMRSs, or both, and the channel estimate information is stored at a buffer of the UE.

Aspect 18: A method for wireless communications, at a network entity, comprising: outputting one or more DMRSs during a first time interval; outputting one or more control messages indicating for a UE to use channel estimate information associated with the one or more DMRSs transmitted during the first time interval for demodulating a data channel during a second time interval, wherein the second time interval occurs temporally after the first time interval; and outputting, via the data channel, a data transmission.

Aspect 19: The method of aspect 18, further comprising: outputting, as part of the one or more control messages, an indication of a time span prior to the second time interval that defines a duration of the first time interval, wherein the one or more DMRSs comprised in the first time interval are based at least in part on the time span indicated in the one or more control messages.

Aspect 20: A UE for wireless communications, comprising one or more memories storing processor-executable code, and one or more processors coupled with the one or more memories and individually or collectively operable to execute the code to cause the UE to perform a method of any of aspects 1 through 17.

Aspect 21: A UE for wireless communications, comprising at least one means for performing a method of any of aspects 1 through 17.

Aspect 22: A non-transitory computer-readable medium storing code for wireless communications, the code comprising instructions executable by one or more processors to perform a method of any of aspects 1 through 17.

Aspect 23: A network entity for wireless communications, comprising one or more memories storing processor-executable code, and one or more processors coupled with the one or more memories and individually or collectively operable to execute the code to cause the network entity to perform a method of any of aspects 18 through 19.

Aspect 24: A network entity for wireless communications, comprising at least one means for performing a method of any of aspects 18 through 19.

Aspect 25: A non-transitory computer-readable medium storing code for wireless communications, the code comprising instructions executable by one or more processors to perform a method of any of aspects 18 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more demodulated reference signals (DMRSs) during a first time interval;
receive one or more control messages indicating for the UE to use channel estimate information associated with the one or more DMRSs received during the first time interval for demodulating a data channel during a second time interval, wherein the second time interval occurs temporally after the first time interval; and
demodulate, via the data channel, a data transmission based at least in part on the channel estimate information.

2. The UE of claim 1, wherein the one or more processors are individually or collectively further operable to execute the code to cause the UE to:
generate a channel estimate of the data channel for the second time interval based at least in part on the channel estimate information associated with the one or more DMRSs received during the first time interval, wherein demodulating the data transmission is based at least in part on the channel estimate.

3. The UE of claim 1, wherein the one or more processors are individually or collectively further operable to execute the code to cause the UE to:
receive, as part of the one or more control messages, an indication of a time span prior to the second time interval that defines a duration of the first time interval, wherein the one or more DMRSs comprised in the first time interval are based at least in part on the time span indicated in the one or more control messages.

4. The UE of claim 3, wherein a first control message of the one or more control messages indicates the time span of the first time interval and a second control message of the one or more control messages indicates for the UE to use the channel estimate information associated with the one or more DMRSs received during the first time interval for demodulating the data channel.

5. The UE of claim 3, wherein a duration of the time span is based at least in part on doppler information associated with the data channel, a buffer storage size of the UE, or both.

6. The UE of claim 1, wherein:
a first set of DMRSs are associated with a first set of DMRS symbols and a first transmission configuration indicator (TCI) state group; and
a second set of DMRSs are associated with a second set of DMRS symbols and a second TCI state group.

7. The UE of claim 6, wherein the first set of DMRSs comprises the one or more DMRSs received during the first time interval, and the one or more processors are individually or collectively further operable to execute the code to cause the UE to:
receive, as part of the one or more control messages, an indication of a DMRS symbol index that indicates the first set of DMRS symbols associated with the first set of DMRSs, wherein the channel estimate information is based at least in part on the first set of DMRSs.

8. The UE of claim 6, wherein the first set of DMRSs comprises the one or more DMRSs received during the first time interval, the data channel associated with the second time interval is associated with the first TCI state group, and the one or more processors are individually or collectively further operable to execute the code to cause the UE to:
receive, as part of the one or more control messages, an indication for the UE to use the channel estimate information associated with the first set of DMRSs for demodulating the data channel based at least in part on the first set of DMRSs and the data channel being associated with the first TCI state group.

9. The UE of claim 1, wherein:
a first set of DMRS tones is associated with a first set of precoding resource groups (PRGs) associated with a first precoder; and
a second set of DMRS tones is associated with a second set of PRGs associated with a second precoder.

10. The UE of claim 9, wherein the first set of DMRS tones corresponds to the one or more DMRSs received during the first time interval, the data channel associated with the second time interval is associated with the first precoder, and the one or more processors are individually or collectively further operable to execute the code to cause the UE to:
receive, as part of the one or more control messages, an indication for the UE to use the channel estimate information associated with the first set of DMRS tones for demodulating the data channel based at least in part on the first set of DMRS tones and the data channel being associated with the first precoder.

11. The UE of claim 10, wherein the indication for the UE to use the channel estimate information associated with the first set of DMRS tones comprises an indication of each PRG of the first set of PRGs associated with the first precoder.

12. The UE of claim 10, wherein:
the indication for the UE to use the channel estimate information associated with the first set of DMRS tones comprises a bit map;
each bit of the bit map is associated with a respective PRG comprised within the one or more DMRSs; and
each bit of the bit map associated with a PRG of the first set of PRGs is set to a first value that indicates for the UE to use the channel estimate information associated with the first set of PRGs.

13. The UE of claim 10, wherein:
the first set of PRGs are contiguous across a first set of frequency resources and the second set of PRGs are contiguous across a second set of frequency resources;
the indication for the UE to use the channel estimate information associated with the first set of DMRS tones comprises a bit map; and
a first bit of the bit map is associated with the first set of PRGs and set to a first value that indicates for the UE to use the channel estimate information associated with the first set of PRGs.

14. The UE of claim 1, wherein the one or more processors are individually or collectively further operable to execute the code to cause the UE to:
transmit a capability message that indicates one or more parameters associated with using one or more previous DMRSs to perform channel estimation for data channel demodulation, wherein the one or more control messages is received based at least in part on the capability message.

15. The UE of claim 14, wherein the one or more parameters comprise a maximum time span prior to the second time interval, a quantity of one or more prior DMRS symbols, a quantity of one or more spatial layers, a quantity of one or more antennas at the UE, a quantity of one or more transmission configuration indicator (TCI) groups, a quantity of one or more prior DMRS resource blocks, a capability of the UE for storing temporal information associated with DMRSs, a capability of the UE for storing spatial information associated with DMRSs, and a capability of the UE for storing frequency information associated with DMRSs, or a combination thereof.

16. The UE of claim 14, wherein the one or more parameters comprise a maximum time span prior to the second time interval, a quantity of DMRS resource elements across a temporal domain, a frequency domain, and a spatial domain, or a combination thereof.

17. The UE of claim 1, wherein the channel estimate information associated with the one or more DMRSs comprises a respective set of DMRS tones associated with a respective DMRS of the one or more DMRSs, a respective channel estimate associated with a respective DMRS of the one or more DMRSs, or both, and wherein the channel estimate information is stored at a buffer of the UE.

18. A network entity, comprising:
one or more memories storing processor-executable code; and
one or more processors coupled with the one or more memories and individually or collectively operable to execute the code to cause the network entity to:
output one or more demodulated reference signals (DMRSs) during a first time interval;
output one or more control messages indicating for a user equipment (UE) to use channel estimate information associated with the one or more DMRSs transmitted during the first time interval for demodulating a data channel during a second time interval, wherein the second time interval occurs temporally after the first time interval; and
output, via the data channel, a data transmission.

19. The network entity of claim 18, wherein the one or more processors are individually or collectively further operable to execute the code to cause the network entity to:
output, as part of the one or more control messages, an indication of a time span prior to the second time interval that defines a duration of the first time interval, wherein the one or more DMRSs comprised in the first time interval are based at least in part on the time span indicated in the one or more control messages.

20. A method for wireless communications, at a user equipment (UE), comprising:
receiving one or more demodulated reference signals (DMRSs) during a first time interval;
receiving one or more control messages indicating for the UE to use channel estimate information associated with the one or more DMRSs received during the first time interval for demodulating a data channel during a second time interval, wherein the second time interval occurs temporally after the first time interval; and
demodulating, via the data channel, a data transmission based at least in part on the channel estimate information.
